(19) United States
(12) Patent Application Publication
(10) Pub. No.: US 2010/0161352 A1
(43) Pub. Date: Jun. 24, 2010

(54) SYSTEM AND METHOD FOR PROVIDING HEALTHCARE SERVICES BASED ON INTERNET PROTOCOL TELEVISION

(76) Inventors: Joon Ho LIM, Daejeon (KR); Ho Youl JUNG, Daejeon (KR); Soo Jun PARK, Seoul (KR); Seon Hee PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/490,917

(22) Filed: Jun. 24, 2009

(30) Foreign Application Priority Data
Dec. 22, 2008 (KR) 10-2008-0131605

(51) Int. Cl. G06Q 50/00; G06F 15/16; H04N 7/173; G06F 17/30

(52) U.S. Cl. 705/3; 705/2; 709/203; 709/246; 725/109; 707/E17.044

(57) ABSTRACT

A system and method for providing healthcare services in a ubiquitous environment are disclosed. In order to synthetically manage healthcare related information as well as provide desired healthcare services using an IPTV, an IPTV data center and an IPTV communication network, the system includes at least one health device, a healthcare set-top mounted on the IPTV, and a healthcare server installed at an IPTV data center. The health device collects personal health data, and transfers the collected data based on a Personal Health Device (PHD) standard. The healthcare set-top analyzes the PHD standard personal health data transferred from the at least one health device, converts the analyzed data into Clinical Document Architecture (CDA) standard data, and transfers the converted CDA standard data through an IPTV communication network. The healthcare server synthetically manages the CDA standard data transferred from the healthcare set-top through the IPTV communication network.

### CROSS-REFERENCE TO RELATED APPLICATIONS

This application claims the priority of Korean Patent Application No. 2008-131605, filed on Dec. 22, 2008, in the Korean Intellectual Property Office, the disclosure of which is incorporated herein by reference.

### BACKGROUND OF THE INVENTION

1. Field of the Invention

The present invention relates to a system and method for providing healthcare services based on an Internet Protocol Television (IPTV) in a ubiquitous environment, and more particularly, to a system and method for providing healthcare services based on an IPTV in a ubiquitous environment, in which data is transferred using ISO/IEEE 11073 Personal Health Device (PHD) which is the health device related international standard and Health Level Seven (HL7) which is the medical information related international standard in order to synthetically manage healthcare related information as well as provide desired healthcare services using an IPTV, an IPTV data center and an IPTV communication network.

2. Description of the Related Art

With the increase in awareness of and concern for health maintenance, many technologies for more efficient healthcare have recently been studied. Technologies that fuse health devices capable of checking an individual's personal health, for instance, blood pressure manometers, blood glucose meters, body fat meters, etc., with information technologies, such as fall detection sensors, medication adherence sensors, and electrocardiographic sensors, have been continuously developed.

In spite of the development of various personal health devices, health problems in some parts of the human body may cause fatal damage to the individual health. Therefore, a technique of synthetically managing information on the various health devices is required.

There are known health device related international standards, one of which is ISO/IEEE 11073 Personal Health Device (PHD) (hereinafter, referred to as “PHD standard”). Further, there are known medical information related international standards, one of which is Health Level Seven (HL7).

The purpose of the PHD standard is for providing interoperability between personal health devices. The PHD standard defines the specialization of each personal health device over an ISO/IEEE 11073-20601 based standard such that personal health devices can be operated in a plug-and-play mode.

The HL7 standard is an international standard primarily used in Electronic Health Record (EHR) systems for hospitals, and provides clinical and health data related standards. The HL7 standard is generally composed of V2 message and V3 Clinical Document Architecture (CDA).

In spite of the efforts aimed at the standardization of integrated healthcare management, there are many difficulties in the integrated management of personal health devices in both spatial and temporal aspects.

### SUMMARY OF THE INVENTION

An aspect of the present invention provides technology capable of synthetically managing healthcare related information in an Internet Protocol Television (IPTV) system in which much current research is being made with the goal of providing existing broadcasting communication related content, and in particular, a system and method for providing healthcare services based on an IPTV, which collects healthcare data using a healthcare set-top mounted on the IPTV, transfers this collected information to an IPTV data center through an IPTV communication network, and synthetically manages the healthcare related information at the IPTV data center.

Another aspect of the present invention provides a system and method for providing healthcare services based on an IPTV, in which health device data collected on the basis of a PHD standard which is a health device related international standard can be synthetically managed at the healthcare server of an IPTV data center by applying conversion technology, based on an HL7 CDA standard which is the medical information related international standard, to a healthcare set-top mounted to the IPTV.

According to an aspect of the present invention, there is provided a system for providing healthcare services based on an Internet Protocol Television (IPTV). The system may include: at least one health device collecting personal health data, and transferring the collected data based on a Personal Health Device (PHD) standard; a healthcare set-top mounted on the IPTV, wherein the healthcare set-top converts the PHD standard personal health data transferred from the at least one health device into Clinical Document Architecture (CDA) standard data, and transfers the converted CDA standard data to a healthcare server; and a healthcare server installed at an IPTV data center, wherein the healthcare server synthetically manages the CDA standard data transferred from the healthcare set-top.

Here, the healthcare set-top may include: a PHD standard data processor analyzing the PHD standard personal health data transferred from the at least one health device; and a CDA format converter converting measurement data of the health device, which is transferred through an event report message among the PHD standard personal health data analyzed by the PHD standard data processor, into the CDA standard data.

Further, the CDA standard data may include a header describing meta information and a body describing measurement data. Here, the meta information may include an identification (ID), model name, and software name of the health device, whereas the body may be recorded with personal health record transferred through the event report message.

Also, the at least one health device may perform communications with the healthcare set-top based on one of Zigbee, Bluetooth, Wi-Fi, USB protocol, and Recommended Standard 232(RS-232).

Meanwhile, the healthcare server may store the CDA standard data transferred from the healthcare set-top in a Personal Health Record (PHR) database, and may further include a service server providing healthcare services using information stored in the PHR database. At this time, the service server may provide one of a chronic disease management service, an elderly independent life support service, a health & well-being service, an elderly rehabilitation service, a health education service, and an automatic health content provision service.

According to another aspect of the present invention, there is provided a method for providing healthcare services based on an Internet Protocol Television (IPTV). The method may include: receiving Personal Health Device (PHD) standard personal health data collected from a plurality of health device; analyzing the PHD standard personal health data received through the IPTV and converting the analyzed data into Clinical Document Architecture (CDA) standard data; and transferring the converted CDA standard data to an IPTV data center through an IPTV communication network.

Here, the analyzing of the PHD standard personal health data may include: analyzing and processing the transferred PHD standard personal health data; and converting measurement data of the health devices, which is transferred through an event report message among the personal health data, into the CDA standard data.

Meanwhile, the method may further include storing the transferred CDA standard data in a Personal Health Record (PHR) database.

According to the present invention as described above, the system and method for providing healthcare services is based on an IPTV with a healthcare set-top mounted on the IPTV, collecting healthcare related data from surrounding PHD standard health devices through the healthcare set-top and transferring the collected data to a healthcare server installed at an IPTV data center, thereby synthetically managing the transferred data and providing desired healthcare services. Thus, the system and method can provide healthcare services to users using an existing IPTV communication network, without establishing a separate healthcare network.

Further, the system and method for providing healthcare services based on an IPTV are based on a PHD standard and an HL7 CDA standard, and facilitate interworking between health devices based on the PHD standard and healthcare services based on the HL7 CDA standard.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings in which:

FIG. 1 is a block diagram illustrating the configuration of a system for providing healthcare services based on an Internet Protocol Television (IPTV) in accordance with an exemplary embodiment of the present invention; and

FIG. 2 illustrates the detailed configuration of a healthcare set-top mounted on an IPTV in accordance with an exemplary embodiment of the present invention.

### DETAILED DESCRIPTION OF THE EXEMPLARY EMBODIMENTS

The present invention will now be described more fully with reference to the accompanying drawings, in which exemplary embodiments of the invention are shown. Detailed descriptions of known functions and components will be omitted when it is deemed that such description would detract from the clarity and conciseness of the disclosure of the present invention.

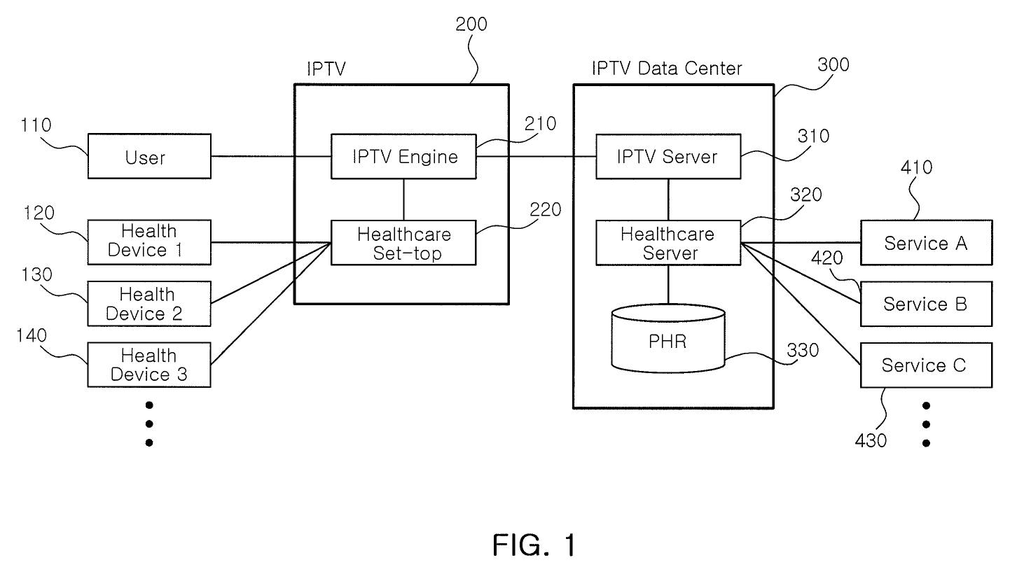

FIG. 1 is a block diagram illustrating the configuration of a system for providing healthcare services based on an Internet Protocol Television (IPTV) in accordance with an exemplary embodiment of the present invention.

The present invention is for providing healthcare services based on an IPTV in a ubiquitous environment, wherein healthcare technology is implanted to an existing IPTV system.

In detail, the present invention is directed to technology of providing IPTV-based healthcare services, in which a healthcare set-top 220 is mounted on an IPTV 200, and a healthcare server 320 capable of synthetically managing the healthcare set-top 220 mounted on the IPTV is installed at an IPTV data center 300, which provides broadcasting communication services through two-way communication with the IPTV. Each component will be described below in detail.

The system for providing IPTV-based healthcare services includes one or more household health devices 120, 130 and 140, a household IPTV 200 mounting a healthcare set-top 220, and an IPTV data center 300 having a healthcare server 320. The system collects data of various household health devices 120, 130 and 140 using the healthcare set-top 220, and transfers the collected data to the healthcare server 320 of the IPTV data center 300. The system can provide a variety of services 410, 420 and 430 requiring health related information using personal health related data managed by the healthcare server 320.

The health devices 120, 130 and 140 collect health data from each person, and automatically transfer the collected data to the healthcare set-top 220 mounted on the household IPTV.

Each of the health devices 120, 130 and 140 includes a fall detection sensor, a medication adherence sensor, an electrocardiographic sensor, or the like, which is to fuse a device, such as a blood pressure manometer, a blood glucose meter, a body fat meter, etc., with information technology.

These health devices 120, 130 and 140 are operated based on an international standard of ISO/IEEE 11073 Personal Health Device (PHD). Further, these health devices 120, 130 and 140 transfer the collected data to the healthcare set-top 220 using a wireless communication protocol such as Zigbee, Bluetooth, and Wi-Fi, or a wired communication protocol such as USB protocol (e.g. “keyed connector” protocol), and Recommended Standard 232 (RS-232).

The healthcare set-top 220, mounted on the IPTV 200, analyzes PHD standard personal healthcare data transferred from the health devices 120, 130 and 140, converts it into Clinical Document Architecture (CDA) standard data, and transfers the converted CDA standard data to the IPTV data center 300 through an IPTV communication network.

The healthcare set-top 220 supports a wireless communication protocol such as Zigbee, Bluetooth, Wi-Fi, etc. or a wired communication protocol such as USB protocol, RS-232, etc. for communication with the health devices 120, 130 and 140.

The healthcare server 320 is installed at the IPTV data center 300, and synthetically manages the CDA standard data transferred from the healthcare set-top 220 through the IPTV communication network. In detail, the healthcare server 320 manages the connected healthcare set-top 220 mounted on each household IPTV 200. Further, the healthcare server 320 monitors device malfunctions and health device data collection situations, thereby determining whether or not each connected healthcare set-top 220 is operating normally.

Also, the healthcare server 320 stores healthcare data collected from each connected healthcare set-top 220 in a Personal Health Record (PHR) database 330 within the IPTV data center. When healthcare services 410, 420 and 430 request to transfer corresponding data, the healthcare server 320 transfer corresponding data in real time.

In order to provide desired services, the healthcare services 410, 420 and 430 can request the healthcare server to transfer real-time data of a specified user using a web service, and searches for a previous health record stored in the PHR database 330.

The healthcare services 410, 420 and 430 include various services provided based on the personal healthcare information transferred and stored by the healthcare server 320. Examples of these healthcare services are as follows: a chronic disease management service, an elderly independent life support service, a health & well-being service, an elderly rehabilitation service, a health education service, an automatic health content provision service, and so on.

Among them, the chronic disease management service includes bi-directional video conversation, medication adherence monitoring, chronic disease management, etc. based on the measurement data of devices such as a blood pressure manometer, a blood glucose meter, an electrocardiographic sensor, a medication adherence detection sensor and so on.

The elderly independent life support service includes an emergency situation detection service based on a fall recognition sensor, a daily life monitoring service based on recognition of daily life patterns such as sleeping, eating, going out, and so on, and a customized content and family content provision service for relieving the loneliness of the elderly.

The health & well-being service includes a biological information monitoring service for use during exercise, an exercise and diet counseling service, an exercise prescription and personal trainer service, an obesity management program service, and so on.

The elderly rehabilitation service includes elderly rehabilitation services based on various gymnastics and yoga programs as well as dementia prevention and brain function improvement services based on the development of content helpful to brain activity.

The health education service includes a usage education service for household health measurement devices, and a chronic disease and health & well-being education content provision service.

The automatic health content provision service includes services based on device data mining, for instance an anti smoking content provision service based on smoking detection sensor mining and an ingredient and effect/side-effect related content provision service provided when it is detected through a medication adherence sensor that medication has been taken.

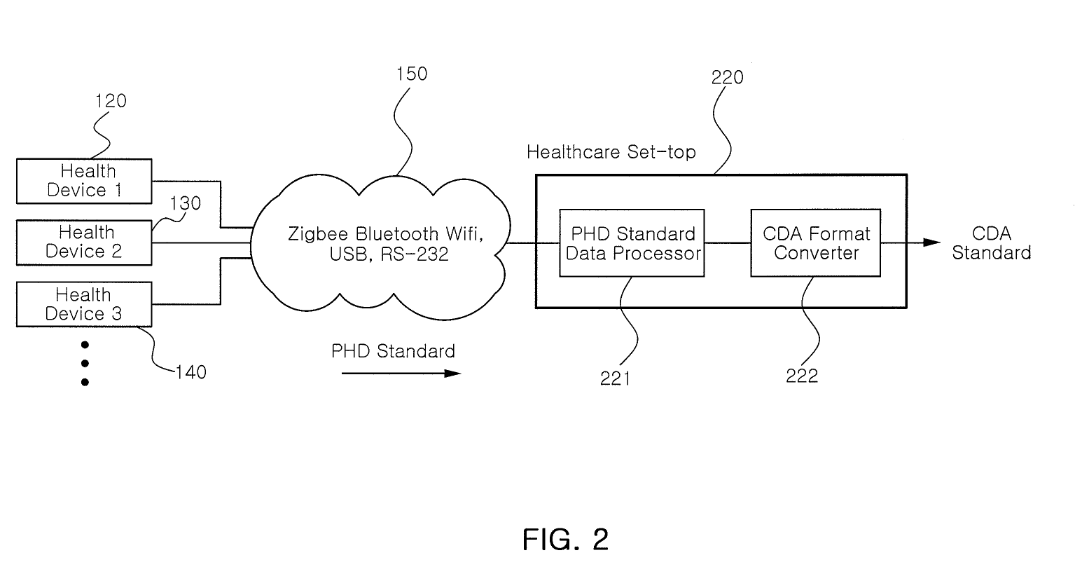

FIG. 2 illustrates the detailed configuration of a healthcare set-top mounted on an IPTV in accordance with an exemplary embodiment of the present invention.

The healthcare set-top 220 includes a PHD standard data processor 221 that collects, analyzes and processes PHD standard data from the health devices 120, 130 and 140, and a CDA format converter 222 that converts the PHD standard data into a CDA standard data having an HL7 CDA format.

The PHD standard data processor 221 processes data received from the health devices 120, 130 and 140 on the basis of the PHD standard. The PHD standard data processor 221 processes PHD standard messages such as association requests, configuration, get service, event reports, and associated release messages. These PHD standard messages are transceived between the health devices 120, 130 and 140 and the healthcare set-top 220.

The PHD standard data processor 221 supports both an agent-initiated mode and a manager-initiated mode depending on a mode in which the personal health device transfers measurement data. When the personal health device includes a PM-store or scanner object, the PHD standard data processor 221 is set to collect data of a PM-store, and activate an operational state of a scanner to transfer the data.

The CDA format converter 222 converts the personal health data transferred in a PHD standard format into CDA standard data having an HL7 CDA format. The CDA standard data includes a header describing document and meta information, and a body describing measurement data.

The header of the CDA standard data describing document and meta information is as follows. An identification (ID), model name, software name, etc. of the device, which are transferred from an MDS object of the PHD is recorded in “extension id” and “assignedAuthoringDevice”. Other pieces of information about ID, code, management organization (custodian), etc. are recorded using values preset by a manager.

```
<?xml version=”1.0” encoding=”UTF-8”?>
<ClinicalDocument xmlns=”urn:h17-org:v3”>
    <typeId extension=”POCD_HD000040”
    root=”2.16.840.1.113883.1.3”/>
    <id root=”1.2.826.0.1.3680043.8.497.1”/>
    <code code=”11492-6” codeSystem=”2.16.840.113883.6.1”
codeSystemName=”LOINC” displayName=”History &amp; physical
note”/>
    <effectiveTime value=”20081008095517+0900”/>
    <confidentialityCode/>
    <recordTarget>
        <patientRole>
            <id root=”1.2.826.0.1.3680043.8.497.3”/>
            <addr></addr>
            <telecom use=”HP” value=””/>
            <patient>
                <name></name>
                <administrativeGenderCode code=””/>
            </patient>
        </patientRole>
    </recordTarget>
    <author>
        <time value=”20081008095517+0900”/>
        <assignedAuthor>
            <id extension=”11000001”
root=”1.2.826.0.1.3680043.8.497.5”/>
            <assignedAuthoringDevice>
                <manufacturerModelName>deviceModelName
</manufacturerModelName>
                <softwareName>deviceSoftwareName
</softwareName>
            </assignedAuthoringDevice>
        </assignedAuthor>
    </author>
    <custodian>
        <assignedCustodian>
            <representedCustodianOrganization>
                <id root=”1.2.826.0.1.3680043.8.497.7”/>
                <name></name>
                <addr></addr>
            </representedCustodianOrganization>
        </assignedCustodian>
    </custodian>
    <component>
        <structuredBody>
        . . .
        </structuredBody>
    </component>
</ClinicalDocument>
```

Further, the CDA body is recorded with real personal health record transferred through the event report message of the PHD. An example of the CDA body is as follows.

```
<structuredBody>
<component>
    <section>
        <code code=”29545-1” codeSystem=”2.16.840.1.113883.6.227”
codeSystemName=”LOINC” displayName=”Physical findings”/>
        <title>Physical findings</title>
        <author>
            <time value=”20081008095517+0900”/>
            <assignedAuthor>
                <id extension=”11000001”
root=”1.2.826.0.1.3680043.8.497.5”/>
                <code code=”11289-6”
codeSystem=”2.16.840.1.113883.11.19341” codeSystemName=”LOINC”
displayName=”Body Temperature”/>
                <effectiveTime value=”20081008095518+0900”/>
                <value value=”25.0”
xmlns:xsi=”http: //www.w3.org/2001/XMLSchema-instance”
xsi:type=”PQ”/>
            </observation>
        </entry>
    </section>
</component>
</structuredBody>
```

In order to integrate the data measured by the health devices 120, 130 and 140, information about each health device is described in a section, and real measurement data is recorded in an observation attribute. Each observation code is converted with reference to a code mapping table. The real measurement value transferred through the event report message is recoded as a value of a “value” string. When numerous measurement values are transferred from the devices, they are recorded in numerous observation attributes.

The code mapping table is a table that stores values of “LOINC” and “SNOMED CT” corresponding to each “TYPE” attribute of a PHD object (wherein the TYPE attribute of the PHD object describes which value a corresponding object measures on the basis of a value of ISO/IEEE 11073-10101 nomenclature). An HL7 CDA conversion module assigns a correct code value to a measurement value of each object transferred through the event report message with reference to corresponding information.

| PHD TYPE | codeSystem | codeSystemName | Code | displayName |
|---|---|---|---|---|
| MDC_PART_SCADA\| | 2.16.840.113883.6.1 | LOINC | 11289-6 | Body |
| MDC_TEMP_BODY | | | | Temperature |
| . . . | | | | |

An HL7 CDA document converted in the way is transferred to the healthcare server 320 located at the IPTV data center 300 through the IPTV communication network.

Although a few exemplary embodiments of the present invention have been shown and described, it will be appreciated by those skilled in the art that modifications and variations can be made in these exemplary embodiments without departing from the principles and spirit of the invention, the scope of which is defined in the appended claims and their equivalents.

What is claimed is:

1. A system for providing healthcare services comprising:
at least one health device collecting personal health data, and transferring the collected data based on a Personal Health Device (PHD) standard;
a healthcare set-top mounted on Internet Protocol TV (IPTV), wherein healthcare set-top converts the PHD standard personal health data transferred from the at least one health device into Clinical Document Architecture (CDA) standard data, and transfers the converted CDA standard data to a healthcare server; and
a healthcare server installed at an IPTV data center, wherein the healthcare server synthetically manages the CDA standard data transferred from the healthcare set-top.

2. The system of claim 1, wherein the healthcare set-top includes:
a PHD standard data processor analyzing the PHD standard personal health data transferred from the at least one health device; and
a CDA format converter converting measurement data of the health device, which is transferred through an event report message among the PHD standard personal health data analyzed by the PHD standard data processor, into the CDA standard data.

3. The system of claim 2, wherein the CDA standard data includes a header describing meta information and a body describing measurement data.

4. The system of claim 3, wherein the meta information includes an identification (ID), model name, and software name of the health device.

5. The system of claim 3, wherein the body is recorded with personal health record transferred through the event report message.

6. The system of claim 1, wherein the at least one health device performs communication with the healthcare set-top based on one of Zigbee, Bluetooth, Wi-Fi, USB protocol, and Recommended Standard 232 (RS-232).

7. The system of claim 1, wherein the healthcare server stores the CDA standard data transferred from the healthcare set-top in a Personal Health Record (PHR) database.

8. The system of claim 7, wherein the healthcare server includes a service server providing healthcare services using information stored in the PHR database.

9. The system of claim 8, wherein the service server provides one of a chronic disease management service, an elderly independent life support service, a health & well-being service, an elderly rehabilitation service, a health education service, and an automatic health content provision service.

10. An Internet Protocol TV (IPTV) comprising:
a healthcare set-top converts a Personal Health Device (PHD) standard personal health data transferred from at least one health device into Clinical Document Architecture (CDA) standard data, and transfers the converted CDA standard data to a healthcare server.

11. The IPTV of claim 10, wherein the healthcare set-top includes:
a PHD standard data processor analyzing the PHD standard personal health data transferred from the at least one health device; and
a CDA format converter converting measurement data of the health device, which is transferred through an event report message among the PHD standard personal health data analyzed by the PHD standard data processor, into the CDA standard data.

12. A method for providing healthcare services comprising:
receiving Personal Health Device (PHD) standard personal health data collected from a plurality of health device;
analyzing the PHD standard personal health data received through the IPTV and converting the analyzed data into Clinical Document Architecture (CDA) standard data; and
transferring the converted CDA standard data to an Internet Protocol TV (IPTV) data center through an IPTV communication network.

13. The method of claim 12, wherein the analyzing of the PHD standard personal health data includes:
analyzing and processing the transferred PHD standard personal health data; and
converting measurement data of the health devices, which is transferred through an event report message among the personal health data, into the CDA standard data.

14. The method of claim 12, further comprising storing the transferred CDA standard data in a Personal Health Record (PHR) database.
